(19) United States
(12) Patent Application Publication
(10) Pub. No.: US 2002/0068886 A1
(43) Pub. Date: Jun. 6, 2002

(54) Detachable, hot-packing and massaging strap

(76) Inventor: Pin-Hung Lin, Taipei (TW)

Correspondence Address: Pin-Hung Lin, PO BOX 82-144, Taipei, TW

(21) Appl. No.: 09/727,484

(22) Filed: Dec. 4, 2000

(51) Int. Cl. A61H 1/00

(52) U.S. Cl. 601/15; 601/151

(57) ABSTRACT

A detachable, air-pressurized, hot-packing massaging strap having a mounting belt formed from a plurality of plate bodies, an air-pressurized hot-packing device mounted on the plate bodies, and a controller for controlling the action of massaging, characterized in that the plate bodies are connected by a connecting device to provide connection and disconnection at respective sections, the front surface of the individual plate bodies are provided with air-filling elements, vibration elements and the air-pressurized hot-packing device is mounted at the rear section of the plate bodies and contains an air-filled air sac, a heat emission element, magnetic stones, a heat isolation liner, and the controller is provided with circuit device and the surface thereof is provided with a plurality of controlling adjusting buttons, thereby in application, the massaging strap is driven by the circuit, and provides to the various part of the human body with intermittent contraction and expansion massaging, hot-packing, and vibration massaging treatment. The massaging strap provides a health effect to different parts of the human body.

### BACKGROUND OF THE INVENTION

(a) Technical Field of the Invention

The present invention relates to a detachable, hot-packing and massaging strap, and in particular, to a massaging strap mounted to any part of the human body to provide hot-packing treatment, intermittent air pressure massage, and vibration massage, or any alternative selection of massaging treatment.

(b) Description of the Prior Art

Owing to fast and prosperous developments in commercial activities, most of the men and women of today are busy with works. In particular, for those man and woman who work in offices and lay against the back of the chair for the entire day, the abdominal of the body grows larger and larger, and back muscle pains are commonly experienced. There are numbers of exercising equipment available in the market to solve these problems. However, this equipment is normally larger in size and clumsy and the structure thereof is complicated. Besides, a particular type of equipment is generally applied only for a specific part of the body. Therefore, it is not economical for the consumer to purchase this equipment. Conventional type of massaging equipment commonly found is the vibration type of massaging device, and the device does not provide an air-pressure massage device. This conventional type of device cannot be detached to use on different parts of the human body, for instance, shoulder, chest, legs, etc. Other conventional type of massaging device is the air-pressurized mounting belt which is mounted at the waist of the human body. However, this device is externally connected to an air-supply source, and the structure is rather complicated. In addition, the parts constituted the device cannot be detached.

### SUMMARY OF THE INVENTION

Accordingly, it is an object of the present invention to provide a detachable, hot packing and massaging strap, wherein the massaging strap can suitably apply on different parts of the human body and is detachable and can be assembled section by section.

Yet another object of the present invention is to provide a detachable, hot packing and massaging strap, wherein the strap has a simple structure which can be easily operated.

An aspect of the present invention is to provide a detachable, air-pressurized, hot-packing massaging strap having a mounting belt formed from a plurality of plate bodies, an air-pressurized hot-packing device mounted on the plate bodies, and a controller for controlling the action of massaging, characterized in that the plate bodies are connected by a connecting device to provide connection and disconnection at respective sections, the front surface of the individual plate bodies are provided with air-filling elements, vibration elements and the air-pressurized hot-packing device is mounted at the rear section of the plate bodies and contains an air-filled air sac, a heat emission element, magnetic stones, a heat isolation liner, and the controller is provided with circuit device and the surface thereof is provided with a plurality of controlling adjusting buttons, thereby in application, the massaging strap is driven by the circuit, and provides to the various part of the human body with intermittent contraction and expansion massaging, hot-packing, and vibration massaging treatment.

Other object and advantages of the present invention will become more apparent from the following description taken in conjunction with the accompanying drawing.

### BRIEF DESCRIPTION OF THE DRAWINGS

FIG. 1 is a perspective view of a detachable, hot-packing and massaging strap of the present invention.

FIG. 2 is a perspective exploded view of a detachable, hot-packing and massaging strap of the present invention.

FIG. 3 is a sectional view along the top horizontal direction of a detachable, hot-packing and massaging strap of the present invention.

FIG. 4 is a schematic view showing the structure of a detachable, hot-packing and massaging strap of the present invention.

FIG. 5 is a schematic view of showing lead wire connection of another structure of the present invention.

FIGS. 6 to 8 show the structure of other preferred embodiments of the present invention.

FIGS. 9 to 13 shows the preferred embodiments mounted on different parts of the human body in accordance with the present invention.

### DETAILED DESCRIPTION OF THE PREFERRED EMBODIMENT

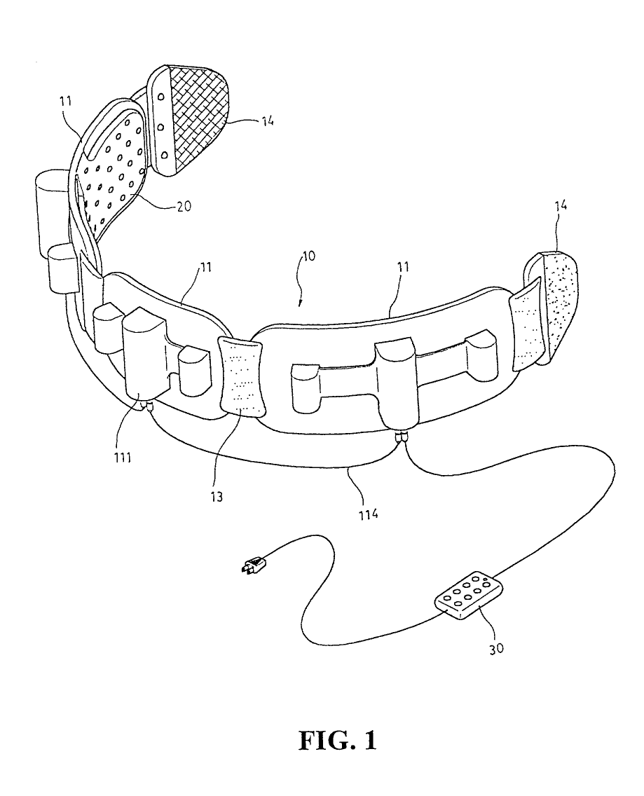

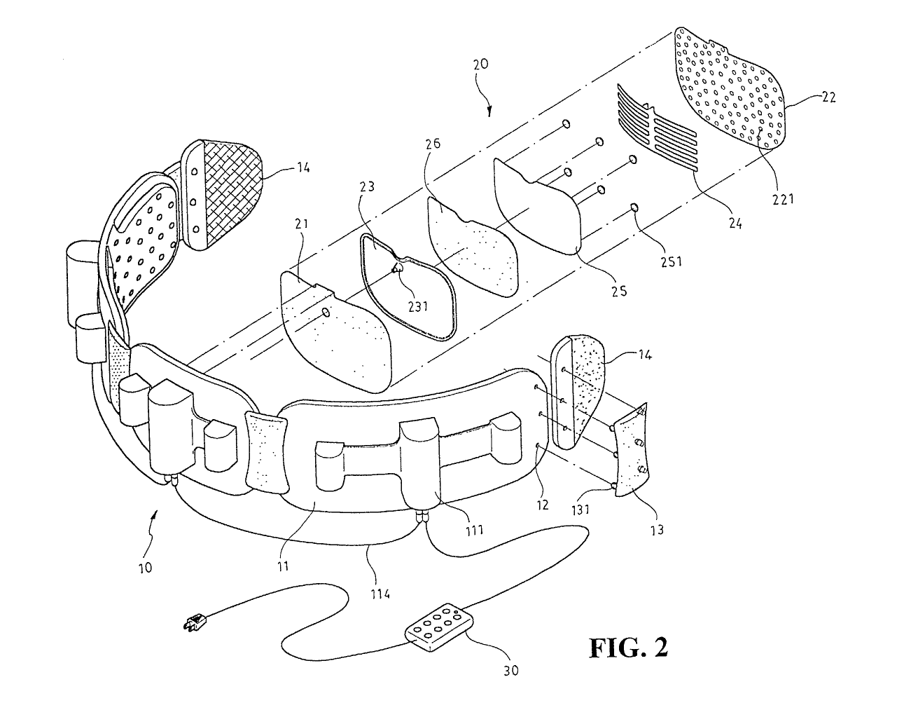

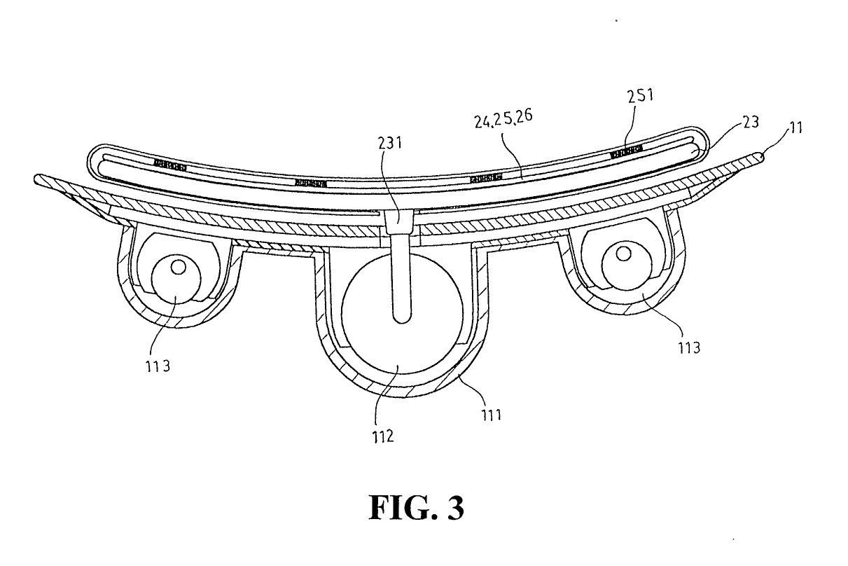

With reference to the accompanying drawings, FIGS. 1, 2 and 3 show a detachable, hot-packing and massaging strap comprising a mounting belt 10, air pressurized hot-packing device 20 and a controller 30. In the present invention, the mounting belt 10 is formed from a plurality of thin plate bodies 11 of varying lengths. Two lateral sides of the plate body 11 are provided with a plurality of holes 12 for the insertion of engaging rods 131 provided on the connection plates 13. Thus, the each plate body 11 is mutually connected and the connection plates 13 can easily be detached from one another. The connection plates 13 at the two ends of the mounting belt 10 are provided with VELCRO fastener 14 and the mounting belt 10 can be tied to any appropriate position on the human body. The front surface of the each plate body 11 is provided with a protective mask 111, and the interior of the protective mask 111 is mounted with an air-filling pump 112 and a plurality of vibrators 113. The air-fling pump 112 produces an expansion action with a relief valve (not shown), and the vibrator 113 can provide a vibration effect. One of the plate bodies 11 can be connected externally with a controller 30, allowing free to detach or connect the controller 30. Lead wires 114 are used to connect the plate bodies 11 such that the individual plate bodies 11 are supplied with electrical power.

In accordance with the present invention, the air-pressurized hot-packing device 20 is mounted at the rear side surface of the plate body 11, and the device 20 is a mask body of appropriate size formed from a front blocking plate 21 and a rear locking plate 22. The outer lateral side of the rear blocking plate 22, which is closely in contact with the surface of the human body, is provided with a plurality of far infra-red ray protrusions 221, thereby blood circulation of the human body can be promoted. The mask body is provided with an air sac 23 (which can be filled with air) and a very thin heat emission element 24. The heat emission element 24 is mounted onto a heat isolation linear 26 by an adhesive plate 25 having a plurality of magnetic stones 251 at one surface. The heat isolation linear 26 is positioned in between the air sac 23 and the heat emission element 24. Thus, the dispersion of heat energy from the heat emission element 24 is effectively prevented, and the heat energy from the heat emission element 24 can be concentrated onto the appropriate part of the body for hot-packing treatment. An air-inlet 231 at the top portion of the air sac 23 passes through the front blocking plate 21 and the plate body 11 and then enters to the protective mask 111 and combines with the air-filling pump 112. Thus, the plate body 11 and the air-pressurized hot-packing device 20 are combined to form as one unit structure, and the protective mask 111 can provide heat energy power source and air pressure source to the air-pressurized hot-packing device 20.

The interior of the controller 30 is provided with a circuit device, and the surface thereof is provided with a plurality of switches and adjusting buttons so as to control the strength of the air-pressure massaging and the vibration massaging, and the temperature of the hot-packing treatment, or for the users selection to proceed to fully automatic action of the massaging strap.

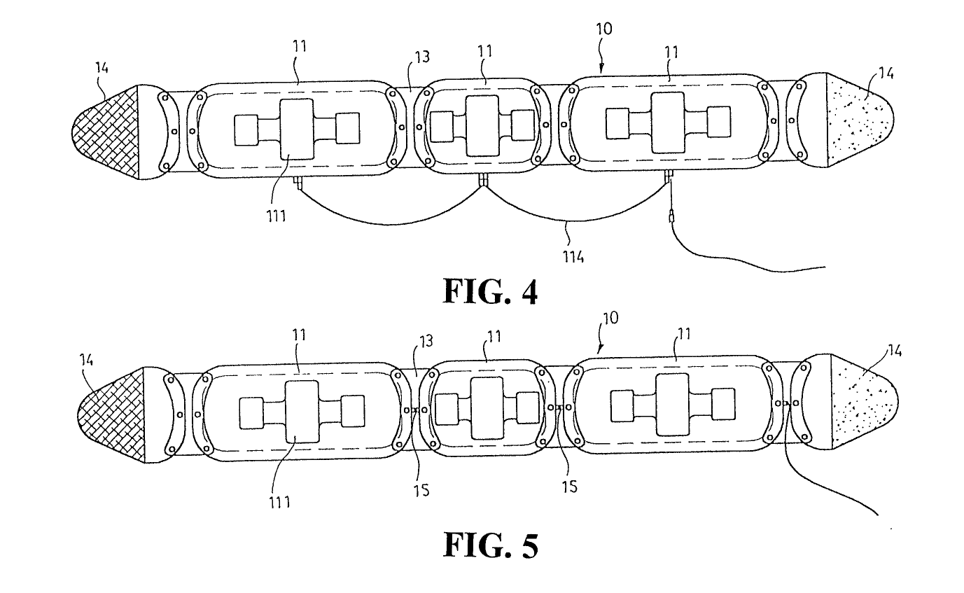

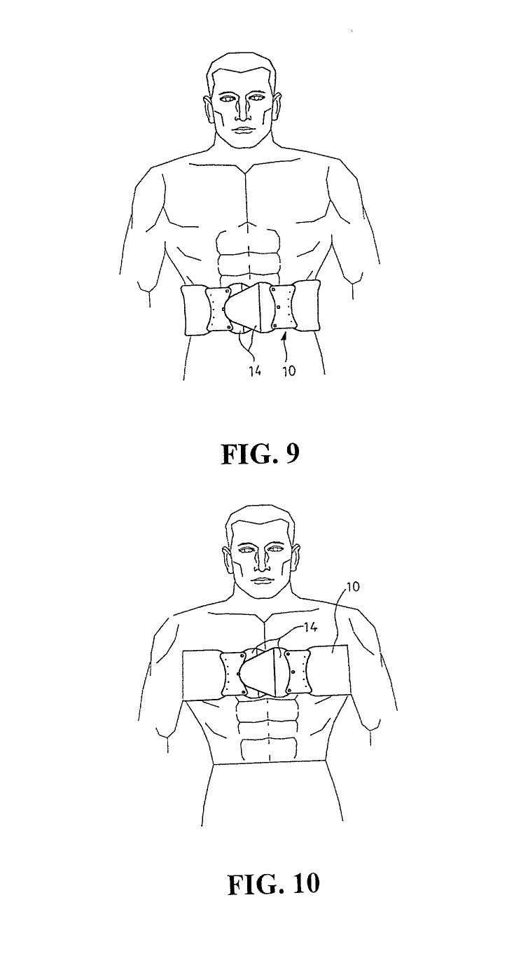

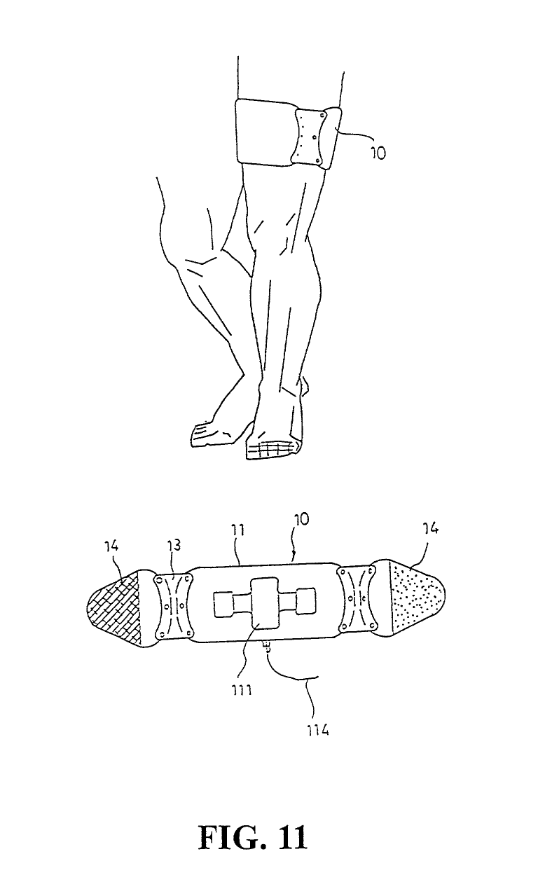

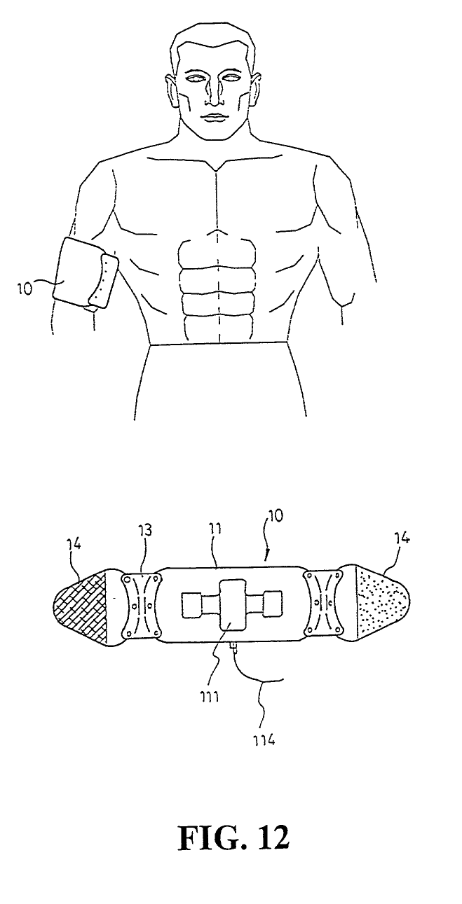

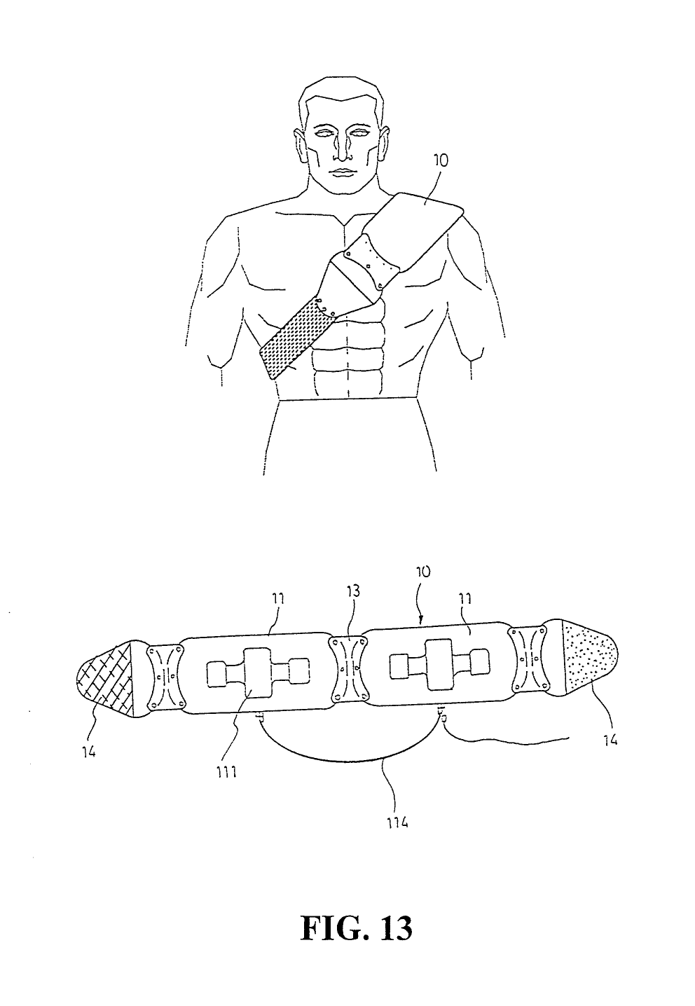

Referring to FIG. 4, and FIGS. 9 to 13, the connection plate 13 enables the plate bodies 11 to be mounted with each other, or forms into a single-structure body. The plate body 11 can be of larger or smaller sizes so as to conveniently secure to the appropriate position on the human body, such as waist, chest, shoulder, hands, legs, etc to provide a health effect. In application, the controller 30 is controlled and based on personal suitability, the strength of pressure, vibration strength and temperature of the hot-packing are set. By the driving of the circuit device, the air sac 23 produces an expansion pressure and the heat emission element 24 produces a hot temperature and the vibrator 113 produces a vibration so as to massage the part of the human body mounted with this massaging strap. In accordance with the present invention, the air sac 23 can produce intermittent expansion which simulates massaging action by fingers of hands. The heat emission element 24 provides a safety temperature and the overall hot-packing massaging is comfortable, and safe. When in use, the controller 30 is used to pre-select the appropriate full automatic action such that the action of air-pressurized massaging, hot-packing treatment, and the vibration massage can be alternatively implemented so as to provide a health effect to the body.

Referring to FIG. 5, the side edges of the connection for the plate bodies 11 are provided with concealed connection points 15 such that during the connection of the plate bodies 11, electric current can pass through the plate bodies 11 so that the troublesome of externally connected lead wires is avoided. Besides, it provides an aesthetic appearance to the overall structure.

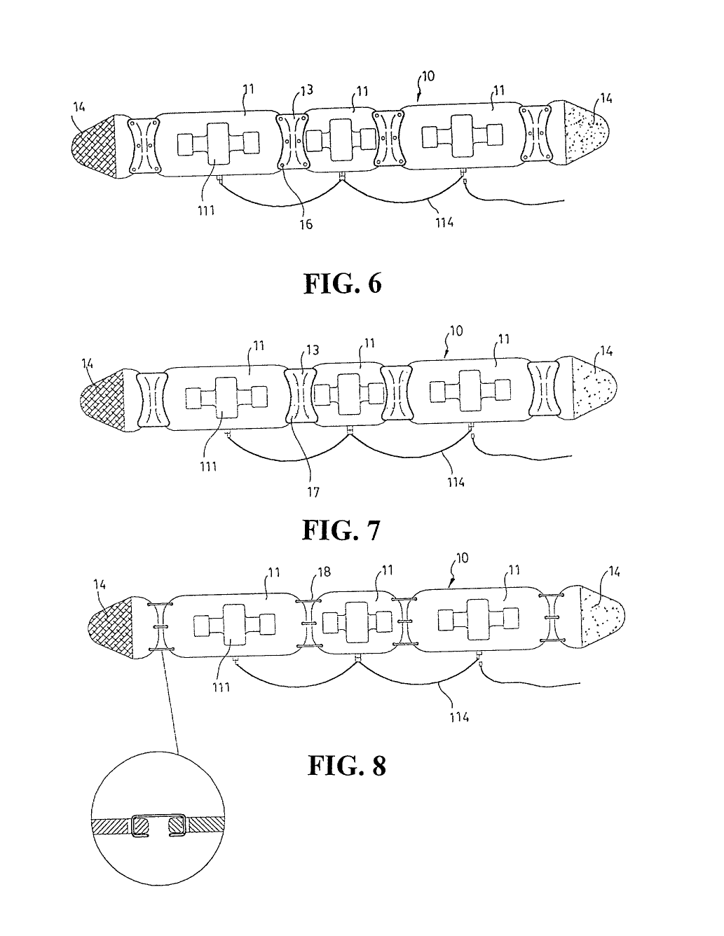

As shown in FIGS. 6, 7 and 8, the structure of the connection plate 13 can be replaced by a rivet button 16, or a VELCRO fastener 17 to achieve the objective of connection of the plate bodies 11. In addition, as shown in FIG. 8, a hook 18 is directly mounted to the connection plate 11 and it also achieve the objective of plate bodies 11 connection.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. A detachable, air-pressurized, hot-packing massaging strap having a mounting belt formed from a plurality of plate bodies, an air-pressurized hot-packing device mounted on the plate bodies, and a controller for controlling the action of massaging, characterized in that
the plate bodies are connected by a connecting device to provide connection and disconnection at respective sections, the front surface of the individual plate bodies are provided with air-filling elements, vibration elements and the air-pressurized hot-packing device is mounted at the rear section of the plate bodies and contains an air-filled air sac, a heat emission element, magnetic stones, a heat isolation liner, and the controller is provided with circuit device and the surface thereof is provided with a plurality of controlling adjusting buttons,
thereby in application, the massaging strap is driven by the circuit, and provides to the various part of the human body with intermittent contraction and expansion massaging, hot-packing, and vibration massaging treatment.

2. A detachable, air-pressurized, hot-packing massaging strap as set forth in claim 1, wherein the controller is detachably mounted with the mounting belt, and the individual plate bodies are detachably connected to each other by lead wires.

3. A detachable, air-pressurized, hot-packing massaging strap as set forth in claim 1, wherein the side edges of the connections of the plate bodies are provided with concealed points.

4. A detachable, air-pressurized, hot-packing massaging straps as set forth in claim 1, wherein the connection device of the plate body is provided with connection plate having engaging rods to engage into the hole of the plate body so as to mount the plate body.

5. A detachable, air-pressurized, hot-packing massaging strap as set forth in claim 4, wherein the connection plate is provided with a rivet button to connect the plate bodies.

6. A detachable, air-pressurized, hot-packing massaging strap as set forth in claim 4, wherein the connection plate is provided with a VELCRO fastener to connect the plate bodies.

7. A detachable, air-pressurized, hot-packing massaging strap as set forth in claim 4, wherein the connection plate is provided with a hook structure to connect the plate bodies.

8. A detachable, air-pressurized, hot-packing massaging strap as set forth in claim 4, wherein the surface of the air-pressurized hot-packing device is mounted with a plurality of far infra red ray protrusions.
